(19) United States
(12) Patent Application Publication
(10) Pub. No.: US 2010/0145618 A1
(43) Pub. Date: Jun. 10, 2010

(54) VEHICLE COLLISION MANAGEMENT SYSTEMS AND METHODS

(75) Inventors: Shih-Yang Lin, Changhua County (TW); Chung-Ming Huang, Kaohsiung City (TW); Chih-Hsun Chou, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INSTITUTE FOR INFORMATION INDUSTRY, Taipei (TW)

(21) Appl. No.: 12/344,797

(22) Filed: Dec. 29, 2008

(30) Foreign Application Priority Data
Dec. 4, 2008 (TW) 97147093

(51) Int. Cl. G08G 1/16

(52) U.S. Cl. 701/301; 340/436

(57) ABSTRACT

Vehicle collision management systems and methods for use in a first vehicle are provided. The system includes an information collection unit, an information filter, and a collision calculation unit. The information collection unit receives driving data corresponding to a second vehicle, wherein the driving data includes a position of the second vehicle, and a driving course and a velocity of the second vehicle. The information filter filters the driving data of the second vehicle according to the driving data of the second vehicle and the first vehicle. The collision calculation unit performs a collision management for the first vehicle according to the filtered driving data of the second vehicle and the first vehicle.

### CROSS REFERENCE TO RELATED APPLICATIONS

This Application claims priority of Taiwan Patent Application No. 097147093, filed on Dec. 4, 2008, the entirety of which is incorporated by reference herein.

### BACKGROUND OF THE INVENTION

1. Field of the Invention

The disclosure relates generally to vehicle collision management systems and methods, and, more particularly to systems and methods that can filter collected data and/or calculate a closest distance for vehicles for collision management.

2. Description of the Related Art

Vehicle safety is always a goal for vehicle vendors. Today, passive safety equipment, such as seat belts, is unsatisfactory given increased safety requirements by drivers. With the advanced development of electronic technology, many active safety detection mechanisms, such as vehicle avoiding-collision systems, have been developed for vehicles.

In prior art, a vehicle can detect a distance from another vehicle via sensors, such as infrared ray, microwave, radio, radar, light signal, and image sensors, and perform related collision management according to the detected distance. In this prior art, since sensor performance may be influenced due to some factors, such as weather and the distance between vehicles, related collision warnings are often incorrect and related collision warning systems are often inefficient.

In another prior art, such as U.S. Pat. No. 7,348,895, a multitude of systems and devices, such as control units, traffic signal control devices, video cameras, and microphones must be set up in traffic lanes in advance to obtain related information of vehicles, and a central server is employed to perform related collision calculations and warnings. In this prior art, the cost for setting up the system infrastructure is very high, and it is not feasible to implement the system in all traffic lanes and/or intersections.

In further another prior art, such as TW 1284297, vehicles can exchange related information via wireless communications. A vehicle computer system can perform related collision calculations according to received information. In this prior art, since the calculation capability of vehicle computer systems is limited, the vehicle computer systems cannot provide real-time and effective collision warnings when a large amount of information is received in a complex traffic environment. Additionally, since the determination of vehicle collision is performed by determining whether the driving paths of different vehicles intersect, incorrect and unwarranted warnings are often generated.

### BRIEF SUMMARY OF THE INVENTION

Vehicle collision management systems and methods are provided.

An embodiment of a vehicle collision management system for use in a first vehicle includes an information collection unit, an information filter, and a collision calculation unit. The information collection unit receives driving data corresponding to at least a second vehicle, wherein the driving data includes a position of the second vehicle, and a driving course and a velocity of the second vehicle. The information filter filters the driving data of the second vehicle according to the driving data of the second and first vehicles. The collision calculation unit performs a collision management for the first vehicle according to the filtered driving data of the second vehicle and the driving data of the first vehicle.

An embodiment of a vehicle collision management system for use in a first vehicle includes an information collection unit and a collision calculation unit. The information collection unit receives driving data corresponding to at least a second vehicle, wherein the driving data includes a position of the second vehicle, and a driving course and a velocity of the second vehicle. The collision calculation unit calculates a closest distance (distance to closest point of approach, DCPA) for the first vehicle and the second vehicle according to the driving data of the second and first vehicles, and determines whether a collision may likely occur for the second vehicle and the first vehicle according to the closest distance.

In an embodiment of a vehicle collision management method, driving data corresponding to at least a second vehicle is received by a first vehicle, wherein the driving data includes a position of the second vehicle, and a driving course and a velocity of the second vehicle. Then, the driving data of the second vehicle is filtered according to the driving data of the second and first vehicles. Thereafter, a collision management is performed for the first vehicle according to the filtered driving data of the second vehicle and the driving data of the first vehicle.

In an embodiment of a vehicle collision management method, driving data corresponding to at least a second vehicle is received by a first vehicle, wherein the driving data includes a position of the second vehicle, and a driving course and a velocity of the second vehicle. Then, a closest distance (distance to closest point of approach, DCPA) for the first vehicle and the second vehicle is calculated according to the driving data of the second and first vehicles, and it is determined whether a collision may likely occur for the second vehicle and the first vehicle according to the closest distance.

Vehicle collision management systems and methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a vehicle collision management system of the invention;

FIG. 2 is a schematic diagram illustrating an embodiment of an example for calculating a DCPA (distance to closest point of approach) and a TCPA (time to closest point of approach) of the invention;

FIG. 3 is a flowchart of an embodiment of a vehicle collision management method of the invention;

FIG. 4 is a flowchart of an embodiment of a warning message generation method of the invention;

FIG. 5 is a schematic diagram illustrating another embodiment of a vehicle collision management system of the invention; and

FIG. 6 is a flowchart of another embodiment of a vehicle collision management method of the invention.

### DETAILED DESCRIPTION OF THE INVENTION

Vehicle collision management systems and methods are provided.

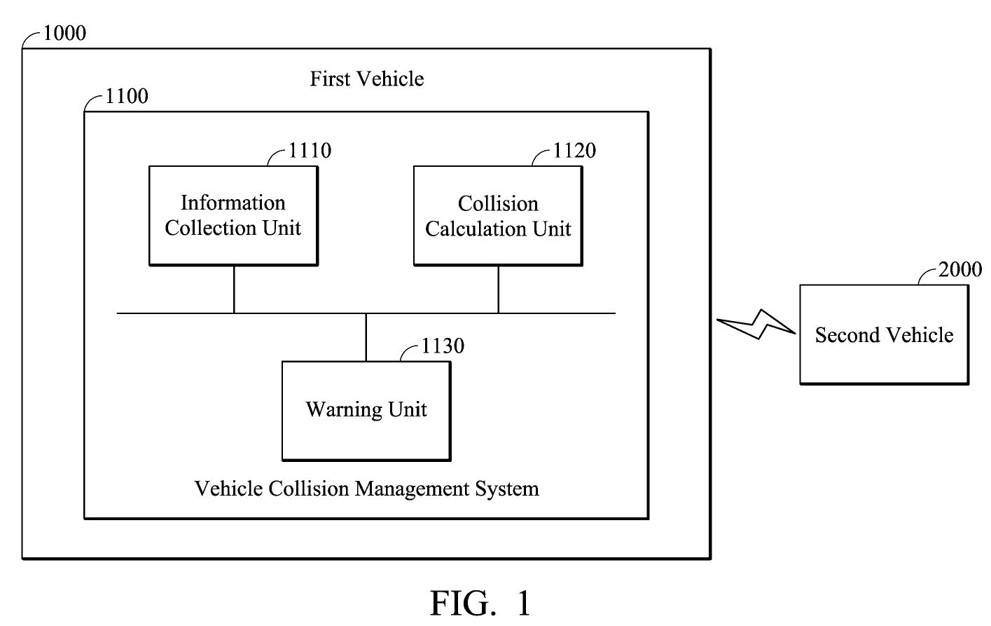

FIG. 1 is a schematic diagram illustrating an embodiment of a vehicle collision management system of the invention.

The vehicle collision management system 1100 may be an electronic device in a first vehicle 1000. The vehicle collision management system 1100 comprises an information collection unit 1110, a collision calculation unit 1120, and a warning unit 1 130. The information collection unit 1110 can wirelessly receive driving data corresponding to at least a second vehicle 2000. The driving data may comprise a position of the second vehicle 2000, and a driving course and a velocity of the second vehicle 2000. It is understood that, in some embodiments, the driving data may also comprise an identification of the second vehicle 2000 to identify itself among other vehicles. It is noted that, the vehicle collision management system 1100 of the first vehicle 1000 may further comprise a data transmission unit (not shown) to periodically transmit the driving data of the first vehicle 1000 to other vehicles. The collision calculation unit 1120 can perform a collision management according to the driving data of the first vehicle 1000 and the received driving data of the second vehicle 2000. Related detail of the collision management is discussed later. The collision calculation unit 1120 can output a result of the collision management to the warning unit 1130. The warning unit 1130 can determine whether to generate a warning message according to the result of the collision management. In some embodiments, the warning unit 1130 can further store the result of the collision management.

In this embodiment, the collision calculation unit 1120 can calculate a DCPA (distance to closest point of approach) and/or a TCPA (time to closest point of approach) according to the driving data of the first vehicle 1000 and the received driving data of the second vehicle 2000. DCPA represents a closest distance between two vehicles. TCPA represents a time that for the two vehicles to reach the closest distance. The calculation of the DCPA and TCPA is discussed as follow.

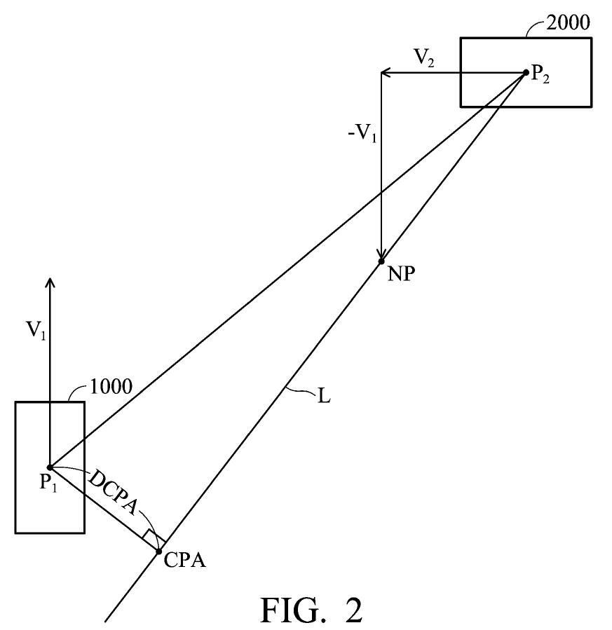

FIG. 2 is a schematic diagram illustrating an embodiment of an example for calculating a DCPA and a TCPA of the invention. It is assumed that the driving unit vector (driving course and velocity) of the second vehicle 2000 is V₂, and the driving unit vector of the first vehicle 1000 is V₁. First, the position P₂ of the second vehicle 2000 is added with the driving unit vector V₂ of the second vehicle 2000 and the inversed driving unit vector (−V₁) of the first vehicle 1000 to obtain a new position NP. Then, the position P₂ of the second vehicle 2000 and the new position NP is connected to form a line L. The shortest distance from the first vehicle 1000 to the line L is calculated according to the position P₁ of the first vehicle 1000. The shortest distance is the DCPA. Thereafter, the distance between the position CPA that is closest to the first vehicle 1000 on the line L and the position P₂ of second vehicle 2000 is divided by the distance between the new position NP and the position P₂ of second vehicle 2000 to obtain the TCPA. Therefore, after the TCPA is reached, the distance between the first vehicle 1000 and the second vehicle 2000 is the DCPA.

In some embodiments, a first slope of a line formed by the first vehicle 1000 and the second vehicle 2000, a second slope of a line formed by the new position NP and the second vehicle 2000, and an included angle between the two slopes (lines) can be first calculated. The DCPA can be calculated according to the included angle and the distance between the first vehicle 1000 and the second vehicle 2000. Additionally, the distance between the second vehicle 2000 and the position CPA can be also calculated according to the included angle and the distance between the first vehicle 1000 and the second vehicle 2000. The distance between the position CPA and the second vehicle 2000 is divided by the distance between the new position NP and the second vehicle 2000 to obtain the TCPA.

It is understood that the method for calculating the DCPA and TCPA is not limited thereto. After the DCPA and TCPA are obtained, the warning unit 1130 can determine whether to generate a warning message according to the DCPA and/or TCPA.

In some embodiments, a predefined time value can be set in the warning unit 1130. Various effects of warning levels can be achieved by setting the predefined time value according to different requirements via an interface (not shown). When the TCPA is less than the predefined time value, the warning unit 1130 can generate a warning message. In some embodiments, a predefined distance value can be set in the warning unit 1130. Similarly, users can set the predefined distance value according to the size of a vehicle via an interface (not shown). When the DCPA is less than the predefined distance value, the warning unit 1130 can generate a warning message. It is noted that, in some embodiments, when the TCPA is less than the predefined time value, and the DCPA is less than the predefined distance value, the warning unit 1130 can generate a warning message.

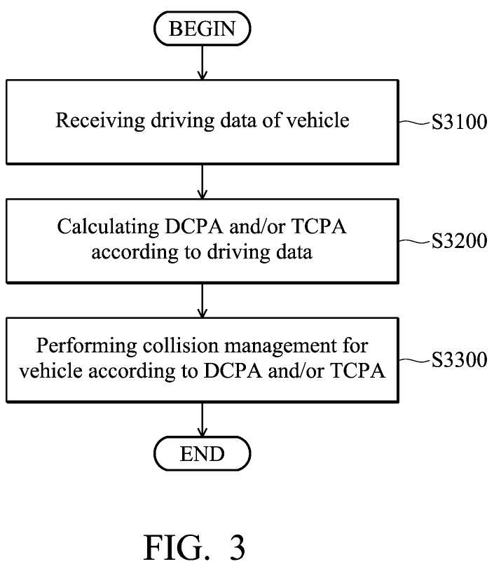

FIG. 3 is a flowchart of an embodiment of a vehicle collision management method of the invention.

In step S3100, the first vehicle 1000 receives the driving data corresponding to the second vehicle 2000 from the second vehicle 2000. The driving data may comprise a position of the second vehicle 2000, and a driving unit vector (driving course and velocity) of the second vehicle 2000. In step S3200, the DCPA and/or TCPA are calculated according to the driving data of the first vehicle 1000 and the driving data of the second vehicle 2000. The calculation of the DCPA and/or TCPA is similar to FIG. 2 and related descriptions, is omitted here. Then, in step S3300, a collision management is performed for the first vehicle 1000 according to the DCPA and/or TCPA.

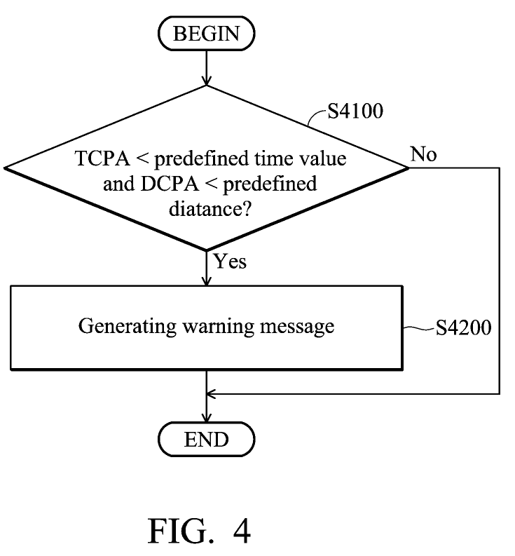

The collision management can be performed by generating a warning message according to the DCPA and/or TCPA. FIG. 4 is a flowchart of an embodiment of a warning message generation method of the invention. In step S4100, it is determined whether the TCPA is less than a predefined time value, and the DCPA is less than a predefined distance value. If the TCPA is not less than the predefined time value, or the DCPA is not less than the predefined distance value, the procedure is completed. If the TCPA is less than the predefined time value, and the DCPA is less than the predefined distance value, a warning message is generated to be prompted. It is understood that, the predefined time value and the predefined distance value can be set according to different requirements. As described, the collision management can be performed by generating a warning message according to the DCPA and/or TCPA. In some embodiments, when the TCPA is less than the predefined time value, a warning message is generated to be prompted. In some embodiments, when the DCPA is less than the predefined distance value, a warning message is generated to be prompted. Additionally, in some embodiments, it does not matter if a warning message is generated, the DCPA and TCPA are recorded.

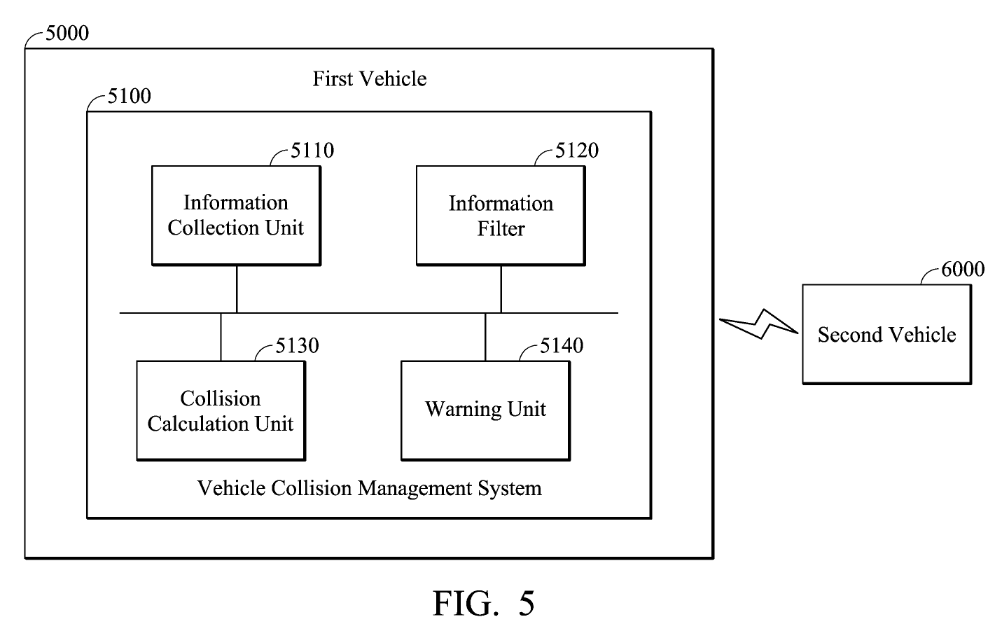

FIG. 5 is a schematic diagram illustrating another embodiment of a vehicle collision management system of the invention.

The vehicle collision management system 5100 may be an electronic device in a first vehicle 5000. The vehicle collision management system 5100 comprises an information collection unit 5110, an information filter 5120, a collision calculation unit 5130, and a warning unit 5140. The information collection unit 1110 can wirelessly receive driving data corresponding to at least a second vehicle 6000. The driving data may comprise a position of the second vehicle 6000, and a driving course and a velocity of the second vehicle 6000. It is understood that, in some embodiments, the driving data may also comprise an identification of the second vehicle 6000 to identify itself among other vehicles. It is noted that, the vehicle collision management system 5100 of the first vehicle 5000 may further comprise a data transmission unit (not shown) to periodically transmit the driving data of the first vehicle 5000 to other vehicles.

The information filter 5120 can filter the driving data of the second vehicle 6000 according to the driving data of the first vehicle 5000 and the second vehicle 6000. In some embodiments, the information filter 5120 can filter the driving data of the second vehicle 6000 according to the velocity of the second vehicle 6000 and the distance between the second vehicle 6000 and the first vehicle 5000. In some embodiments, when the distance is greater than a first predefined distance and less than a second predefined distance, and the velocity of the second vehicle 6000 is greater than a predefined velocity, the information filter 5120 can keep and provide the driving data of the second vehicle 6000 to the collision calculation unit 5130. For example, when the distance is greater than 300 meters and less than 400 meters, and the velocity of the second vehicle 6000 is greater than 90 km/hr, the driving data of the second vehicle 6000 is kept. When the distance is greater than 200 meters and less than 300 meters, and the velocity of the second vehicle 6000 is greater than 60 km/hr, the driving data of the second vehicle 6000 is kept. When the distance is greater than 100 meters and less than 200 meters, and the velocity of the second vehicle 6000 is greater than 30 km/hr, the driving data of the second vehicle 6000 is kept. Additionally, in some embodiments, when the distance is less than a specific distance, such as 100 meters, the information filter 5120 can keep and provide the driving data of the second vehicle 6000 to the collision calculation unit 5130.

Further, in some embodiments, the information filter 5120 can filter the driving data of the second vehicle 6000 according to the position and the driving course of the second vehicle 6000. In some embodiments, when the position of the second vehicle 6000 is within a first predefined degree and a second predefined degree in relation to the relative bearing of the first vehicle 5000, and the driving course of the second vehicle 6000 is toward a range between a third predefined degree and a fourth predefined degree of the relative course of the first vehicle 5000, the information filter 5120 can keep and provide the driving data of the second vehicle 6000 to the collision calculation unit 5130. For example, when the position of the second vehicle 6000 is within 0 degree and 180 degree in relation to the relative bearing of the first vehicle 5000, and the driving course of the second vehicle 6000 is toward the range between 180 degree and 360 degree of the relative course of the first vehicle 5000, the driving data of the second vehicle 6000 is kept. When the position of the second vehicle 6000 is within 180 degree and 360 degree in relation to the relative bearing of the first vehicle 5000, and the driving course of the second vehicle 6000 is toward the range between 0 degree and 180 degree of the relative course of the first vehicle 5000, the driving data of the second vehicle 6000 is kept.

Further, in some embodiments, the information filter 5120 can first determine a specific quadrant where the second vehicle 6000 is located in relation to the relative bearing of the first vehicle 5000, and determine a corresponding filter rule according to the specific quadrant. Then, the driving data of the second vehicle 6000 is filtered according to the determined filter rule. For example, when the second vehicle 6000 is at the first quadrant (0 degree to 90 degree) in relation to the relative bearing of the first vehicle 5000, the corresponding filter rule is to determine whether the driving course of the second vehicle 6000 is toward the range between 180 degree and 360 degree of the relative course of the first vehicle 5000. If so, the driving data of the second vehicle 6000 is kept. When the second vehicle 6000 is at the second quadrant (270 degree to 360 degree) in relation to the relative bearing of the first vehicle 5000, the corresponding filter rule is to determine whether the driving course of the second vehicle 6000 is toward the range between 0 degree and 180 degree of the relative course of the first vehicle 5000. If so, the driving data of the second vehicle 6000 is kept. When the second vehicle 6000 is at the third quadrant (180 degree to 270 degree) in relation to the relative bearing of the first vehicle 5000, the corresponding filter rule is to determine whether the driving course of the second vehicle 6000 is toward the range between 0 degree and 90 degree of the relative course of the first vehicle 5000. If so, the driving data of the second vehicle 6000 is kept. When the second vehicle 6000 is at the fourth quadrant (90 degree to 180 degree) in relation to the relative bearing of the first vehicle 5000, the corresponding filter rule is to determine whether the driving course of the second vehicle 6000 is toward the range between 270 degree and 360 degree of the relative course of the first vehicle 5000. If so, the driving data of the second vehicle 6000 is kept. It is understood that, the above filter rules can be simultaneously or solely used. The present invention is not limited to any filter rule and manner.

The information filter 5120 can provide the filtered driving data of the second vehicle 6000 to the collision calculation unit 5130. The collision calculation unit 5130 can perform a collision management according to the driving data of the first vehicle 1000 and the received driving data of the second vehicle 2000. The warning unit 5140 can determine whether to generate a warning message according to the result of the collision management. In some embodiments, the warning unit 1130 can further store the result of the collision management.

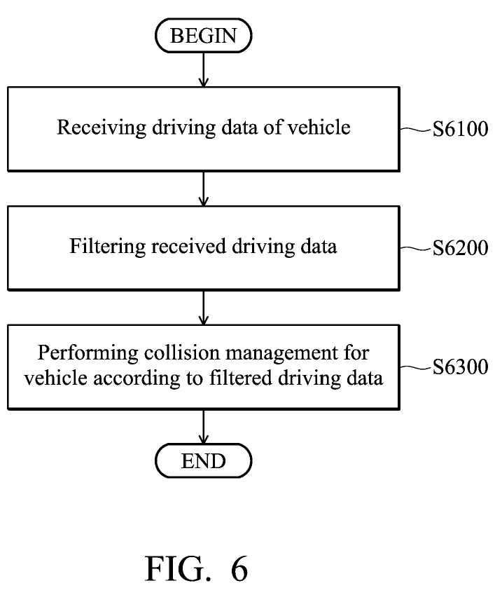

FIG. 6 is a flowchart of another embodiment of a vehicle collision management method of the invention.

In step S6100, the first vehicle 5000 receives the driving data corresponding to the second vehicle 6000 from the second vehicle 6000. The driving data may comprise a position of the second vehicle 2000, and a driving unit vector (driving course and velocity) of the second vehicle 2000. In step S6200, the driving data of the second vehicle 6000 is filtered according to the driving data of the first vehicle 5000 and the second vehicle 6000. In some embodiments, the driving data of the second vehicle 6000 can be filtered according to the velocity of the second vehicle 6000 and the distance between the second vehicle 6000 and the first vehicle 5000. In some embodiments, the driving data of the second vehicle 6000 can be filtered according to the position and the driving course of the second vehicle 6000. In some embodiments, a specific quadrant where the second vehicle 6000 located in relation to the relative bearing of the first vehicle 5000 can first be determined, and a corresponding filter rule would be determined according to the specific quadrant. Then, the driving data of the second vehicle 6000 would be filtered according to the determined filter rule. It is noted that, the above embodiments are examples of the present invention, and not limited thereto. Then, in step S6300, a collision management is performed for the first vehicle 5000 according to the filtered driving data. Similarly, in some embodiments, the collision management can be performed by calculating the DCPA and/or TCPA, and generating a warning message according to the DCPA and/or TCPA.

Therefore, the vehicle collision management systems and methods can filter collected data and/or calculate the DCPA and/or TCPA for vehicles for collision management.

Vehicle collision management systems and methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A vehicle collision management system for use in a first vehicle, comprising:
an information collection unit receiving driving data corresponding to at least a second vehicle, wherein the driving data comprises a position of the second vehicle, and a driving course and a velocity of the second vehicle;
an information filter filtering the driving data of the second vehicle according to the driving data of the second and first vehicles; and
a collision calculation unit performing a collision management for the first vehicle according to the filtered driving data of the second vehicle and the driving data of the first vehicle.

2. The system of claim 1, wherein the information filter filters the driving data of the second vehicle according to the velocity of the second vehicle and a distance between the second vehicle and the first vehicle, or according to the position and the driving course of the second vehicle.

3. The system of claim 2, wherein when the distance is greater than a first predefined distance and less than a second predefined distance, and the velocity of the second vehicle is greater than a predefined velocity, or when the distance is less than a third predefined distance, the information filter keeps and provides the driving data of the second vehicle to the collision calculation unit.

4. The system of claim 2, wherein when the position of the second vehicle is within a first predefined degree and a second predefined degree in relation to the relative bearing of the first vehicle, and the driving course of the second vehicle is toward a range between a third predefined degree and a fourth predefined degree of the relative course of the first vehicle, the information filter keeps and provides the driving data of the second vehicle to the collision calculation unit.

5. The system of claim 2, wherein the information filter further determines a specific quadrant where the second vehicle is located in relation to the relative bearing of the first vehicle, determines a corresponding filter rule according to the specific quadrant, and filters the driving data of the second vehicle according to the determined filter rule.

6. The system of claim 1, wherein the collision calculation unit further calculates a distance to a closest point of approach (DCPA) for the first vehicle and the second vehicle according to the filtered driving data of the second vehicle and the driving data of the first vehicle, and determines whether a collision may likely occur for the second vehicle and the first vehicle according to the DCPA.

7. The system of claim 6, further comprising a warning unit determining whether to generate a warning message according to the DCPA or a time to a closest point of approach (TCPA), wherein the TCPA is calculated by the collision calculation unit according to the filtered driving data of the second vehicle and the driving data of the first vehicle, and generating the warning message when the DCPA is less than a fourth predefined distance or the TCPA is less than a predefined time value.

8. A vehicle collision management system for use in a first vehicle, comprising:
an information collection unit receiving driving data corresponding to at least a second vehicle, wherein the driving data includes a position of the second vehicle, and a driving course and a velocity of the second vehicle; and
a collision calculation unit calculating a distance to a closest point of approach (DCPA) for the first vehicle and the second vehicle according to the driving data of the second and first vehicles, and determining whether a collision may likely occur for the second vehicle and the first vehicle according to the DCPA.

9. The system of claim 8, further comprising a warning unit determining whether to generate a warning message according to the DCPA or a time to closest point of approach (TCPA), wherein the TCPA is calculated by the collision calculation unit according to the filtered driving data of the second vehicle and the driving data of the first vehicle, and generating the warning message when the DCPA is less than a fourth predefined distance or the TCPA is less than a predefined time value.

10. A vehicle collision management method, comprising:
receiving driving data corresponding to at least a second vehicle by a first vehicle, wherein the driving data comprises a position of the second vehicle, and a driving course and a velocity of the second vehicle;
filtering the driving data of the second vehicle according to the driving data of the second and first vehicles; and
performing a collision management for the first vehicle according to the filtered driving data of the second vehicle and the driving data of the first vehicle.

11. The method of claim 10, wherein the step of filtering the driving data of the second vehicle according to the driving data of the second and first vehicles is performed by filtering the driving data of the second vehicle according to the velocity of the second vehicle and a distance between the second vehicle and the first vehicle, or according to the position and the driving course of the second vehicle.

12. The method of claim 11, wherein when the distance is greater than a first predefined distance and less than a second predefined distance, and the velocity of the second vehicle is greater than a predefined velocity, or when the distance is less than a third predefined distance, the driving data of the second vehicle is kept for the collision management.

13. The method of claim 11, wherein when the position of the second vehicle is within a first predefined degree and a second predefined degree in relation to the relative bearing of the first vehicle, and the driving course of the second vehicle is toward a range between a third predefined degree and a fourth predefined degree of the relative course of the first vehicle, the driving data of the second vehicle is kept for the collision management.

14. The method of claim 11, wherein the step of filtering the driving data of the second vehicle according to the driving data of the second and first vehicles is performed by the steps of:
determining a specific quadrant where the second vehicle is located in relation to the relative bearing of the first vehicle;
determining a corresponding filter rule according to the specific quadrant; and
filtering the driving data of the second vehicle according to the determined filter rule.

15. The method of claim 10, wherein the step of performing a collision management for the first vehicle according to the filtered driving data of the second vehicle and the driving data of the first vehicle comprises the steps of:
calculating a distance to closest point of approach (DCPA) for the first vehicle and the second vehicle according to the filtered driving data of the second vehicle and the driving data of the first vehicle; and
determining whether a collision may likely occur for the second vehicle and the first vehicle according to the DCPA.

16. The method of claim 15, further comprising the steps of:
determining whether to generate a warning message according to the DCPA or a time to closest point of approach (TCPA), wherein the TCPA is calculated according to the filtered driving data of the second vehicle and the driving data of the first vehicle; and
generating the warning message when the DCPA is less than a fourth predefined distance or the TCPA is less than a predefined time value.

17. A vehicle collision management method, comprising:
receiving driving data corresponding to at least a second vehicle by a first vehicle, wherein the driving data includes a position of the second vehicle, and a driving course and a velocity of the second vehicle;
calculating a distance to closest point of approach (DCPA) for the first vehicle and the second vehicle according to the driving data of the second and first vehicles; and
determining whether a collision may likely occur for the second vehicle and the first vehicle according to the DCPA.

18. The method of claim 17, further comprising the steps of:
determining whether to generate a warning message according to the DCPA or a time to closest point of approach (TCPA), wherein the TCPA is calculated by the collision calculation unit according to the filtered driving data of the second vehicle and the driving data of the first vehicle; and
generating the warning message when the DCPA is less than a fourth predefined distance or the TCPA is less than a predefined time value.

19. A machine-readable storage medium comprising a computer program, which, when executed, causes a device to perform a vehicle collision management method, wherein the method comprises:
receiving driving data corresponding to at least a second vehicle by a first vehicle, wherein the driving data comprises a position of the second vehicle, and a driving course and a velocity of the second vehicle;
filtering the driving data of the second vehicle according to the driving data of the second and first vehicles; and
performing a collision management for the first vehicle according to the filtered driving data of the second vehicle and the driving data of the first vehicle.

20. A machine-readable storage medium comprising a computer program, which, when executed, causes a device to perform a vehicle collision management method, wherein the method comprises:
receiving driving data corresponding to at least a second vehicle by a first vehicle, wherein the driving data includes a position of the second vehicle, and a driving course and a velocity of the second vehicle;
calculating a distance to closest point of approach (DCPA) for the first vehicle and the second vehicle according to the driving data of the second and first vehicles; and
determining whether a collision may likely occur for the second vehicle and the first vehicle according to the DCPA.
